(19) United States
(12) Patent Application Publication
(10) Pub. No.: US 2021/0131603 A1
(43) Pub. Date: May 6, 2021

(54) Pipeline Repair Assembly and Method Having Hydrophilic Containment Bands

(71) Applicant: LMK Technologies, LLC, Ottawa, IL (US)

(72) Inventors: Bruce Kamin, Ottawa, IL (US); Rick Gage, Ottawa, IL (US)

(73) Assignee: LMK Technologies, LLC, Ottawa, IL (US)

(21) Appl. No.: 16/669,716

(22) Filed: Oct. 31, 2019

(51) Int. Cl. F16L 55/165; F16L 55/179; F16L 55/26

(52) U.S. Cl. CPC F16L 55/1651; F16L 55/1656; F16L 55/1654; F16L 55/265; F16L 55/179

(57) ABSTRACT

A liner tube is provided for repairing a main pipe line having a lateral pipe line connected thereto. The liner tube assembly includes a liner tube impregnated with a liquid material capable of curing and hardening. The liner tube includes a gasket or junction band positioned about the juncture of the pipe lines. The gasket or bands form a tight seal between the liner tube and the pipe line. Hydrophilic containment bands are positioned over a portion of the gasket or junction band and around the main liner on either side of the juncture of the pipe lines.

### BACKGROUND

The present invention relates to a device and method for repairing pipe, such as underground sewer pipe and the like.

Prior methods for repairing damaged pipe lines include moving a liner tube impregnated with a liquid material capable of curing and hardening to the position within the pipe where the damaged portion is located. The liner tube is urged in an outward radial direction into contact with the pipe line being repaired and the liquid material impregnating the liner tube is permitted to cure and harden. The liner tube forms an interior liner in the pipe for the pipe line being repaired.

On some occasions lateral pipe lines are connected to main pipe lines. Often damage occurs at the Junction between the lateral pipe line and the main pipe line. T-shaped or Y-shaped liner tubes have been utilized to fit within the junction between the lateral pipe line and the main pipe line. Liner tubes form a T-shaped or Y-shaped liner after hardening to the interior of the junction between the lateral pipe line and the main pipe line,

Ground water outside the lateral pipe line and the main pipe line infiltrates through the damaged portion of the pipe line and migrates between the liner tube and the pipe line to a point where it can enter the pipe line. In order to prevent this infiltration of ground water, attempts have been made to adhere the liner tube to the interior surface of the pipe line being repaired, whether it is a single straight pipe tine or a T-shaped or Y-shaped pipe line. Some existing devices address this problem using a compressible gasket at the main/lateral junction to help create a seal. Elastic bands are used to help secure the gasket to the launcher as it travels through the pipe. One problem with these bands is that they can prevent the gasket from fully expanding against the inside of the pipe.

In some instances, shrinkage of the liner can occur, which creates a gap that allows ground water to flow around the liner (between the liner and the interior wall of the pipe) and eventually infiltrate the pipe line. For example, thermoset resins are used in cured-in-place pipe applications to form the liner to the interior of the pipe line. These thermoset resins tend to shrink during the curing process, thus creating a gap between the liner and the pipe. Even the slightest shrinkage in the liner can be problematic.

A primary object of the present invention is the provision of an improved device and method for repairing pipe by using hydrophilic seals or other impermeable compressible materials.

A further object of the present invention is the provision of a device and method for preventing ground water from infiltrating a pipe line near the juncture between a main pipe line and a lateral pipe line.

A further object of the present invention is the provision of a device and method for repairing the juncture between a main pipe line and a lateral pipe line which uses a hydrophilic gasket or gasket of similar impermeable compressible material that seals against entry of ground water at the juncture between the pipe lines, wherein the device further comprises two hydrophilic containment bands positioned on either side of the gasket, over a portion of the gasket, and around the main liner.

A further object of the present invention is the provision of a device and method for repairing the juncture between a main pipe line and a lateral pipe line which uses a hydrophilic junction band or similar article of impermeable compressible material positioned between the main pipe line and the liner around the opening that connects the main pipe line to the lateral pipe line, wherein the device further comprises two hydrophilic containment bands positioned on either side of the junction band, over a portion of the junction band, and around the main liner.

A further object of the present invention is the provision of a device and method for repairing pipe using hydrophilic seals and the like which is economical to manufacture, durable in use, and reliable in operation.

### SUMMARY

According to one feature of the present invention, an apparatus is provided for repairing the juncture between a main pipe line and a lateral pipe line. The apparatus includes a main liner member and a lateral liner tube made of resin absorbent material. A hydrophilic gasket or gasket of similar impermeable compressible material surrounds a portion of both the main liner member and the lateral liner tube and is adapted to be positioned between the host pipes and the liner assembly in operation. The hydrophilic gasket includes a tubular portion that extends at least partially within the lateral liner tube and a flange portion that extends outwardly about the periphery of one end of the tubular portion. The hydrophilic gasket is capable of swelling in response to being exposed to a liquid, such as water, and forms a seal between the liner assembly and the host pipes at the juncture between the host pipes. A first hydrophilic containment band surrounds the main liner member and is positioned between a first portion of the flange portion of the gasket and the main pipe line on one side of the liner juncture. A second hydrophilic containment band surrounds the main liner member and is positioned between a second portion of the flange portion of the gasket and the main pipe line on another side of the liner juncture. The hydrophilic containment bands are capable of swelling in response to being exposed to a liquid, such as water, to form a seal around the entire liner member on different sides of the junction opening, which helps contain water by preventing it from traveling along the pipe in a gap between the outside of the liner and the inside of the pipe. The apparatus can be used in applications where the lateral liner is inverted into the lateral pipe line or in so-called “pull-in-place” applications. In a pull-in-place application, both the main liner and lateral liner are moved through the main pipe line to a position where the lateral liner ultimately extends inside the lateral pipe line and the main liner is positioned in the main pipe line near the junction opening to the lateral pipe line.

According to another feature of the present invention, a single hydrophilic junction band or junction band made of a similar impermeable compressible material is positioned on the main liner portion of a main/lateral liner. The junction band surrounds the opening between the main and lateral liners and is disposed between the main pipe line and the liner around the periphery of the opening between the main and lateral pipes to effectively seal against entry of ground water at the pipe junction. A first containment band surrounds the main liner member and is positioned over a first a first portion of the single junction band so that the first containment band is positioned between the single junction band and the main pipe line on one side of the liner juncture. A second containment band surrounds the main liner member and is positioned over a second portion of the single junction band so that the second containment band is positioned between the second portion of the single junction band and the main pipe line on another side of the liner juncture. The hydrophilic containment bands are capable of swelling in response to being exposed to a liquid, such as water, to form a seal around the entire liner member on different sides of the junction opening, which helps contain water by preventing it &OM traveling along the pipe in a gap between the outside of the liner and the inside of the pipe. Again, this apparatus is suitable for use in both inversion-style applications and pull-in-place applications.

### BRIEF DESCRIPTION OF THE DRAWINGS

FIG. 1 is a perspective view of a repair assembly for repairing a lateral pipe line and a main pipe line.

FIG. 2 is a sectional view of a main pipe line and a lateral pipe line showing one embodiment of the present invention wherein a gasket is used to help seal the junction between the main pipe and the lateral pipe.

FIG. 3 is a view similar to FIG. 2, but showing the liner in its inflated position and the tubular portion of the gasket extending into the lateral pipe.

FIG. 4 is a perspective view of an alternative embodiment of a repair assembly for repairing a lateral pipe line and a main pipe line wherein a junction band is used to help seal the junction between the main and lateral pipe.

FIG. 5 is a sectional view of a main pipe line and a lateral pipe line showing the device in FIG. 4.

FIG. 6 is a view similar to FIG. 5, but showing the liner in its inflated position.

### DETAILED DESCRIPTION

Referring to FIGS. 1-3, a repair assembly is generally designated by the numeral 10. Repair assembly 10 includes a launcher device 12 having mounted thereto a T-shaped or Y-shaped liner assembly 14. Repair assembly 10 also houses a T-shaped or Y-shaped bladder assembly 16. In the particular configuration shown in FIGS. 1-3, the liner assembly 14 and bladder assembly 16 are T-shaped, but they can also be Y-shaped to accommodate a lateral pipe line that intersects with a main pipe line at an oblique angle.

Launcher device 12 includes side walls 18, an end cap 20 and an end wall 22, all of which form a launcher device cavity 48. End cap 20 includes a line inlet 24 through which a line 26 extends. Line 26 is attached to a closed bladder tube end 28. Also extending through end cap 20 is an air inlet 30 which is connected to an air hose 32. T-shaped or Y-shaped bladder tube assembly 16 includes a main bladder tube 34 and a lateral bladder tube 36. Similarly, the T-shaped or Y-shaped liner assembly 14 includes a main liner tube 38 and a lateral liner tube 40. The bladder assembly 16 is fitted on the interior of the liner assembly 14.

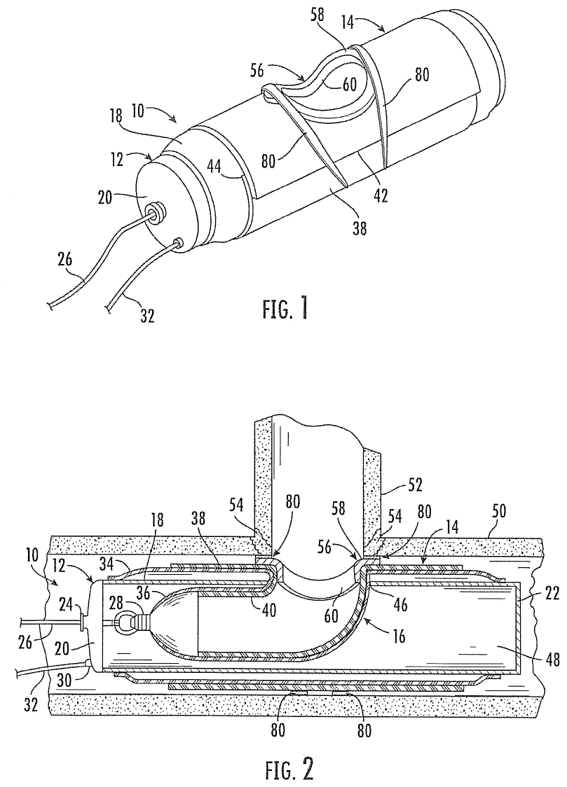

As can be seen in FIG. 1, the main liner tube 38 is comprised of what is initially a flat sheet of material which is wrapped around the outside of the main bladder tube 34 and the launcher device 12. The main liner tube 38 includes overlapping edges 42, 44. The launcher device 12 includes a launcher device opening 46, and the lateral liner tube 40 is contained within the launcher device cavity 48 as shown in FIG. 2. Similarly, the lateral bladder tube 36 is contained within the cavity 48 and surrounds the lateral liner tube 40. Both the main liner tube 38 and the lateral liner tube 40 are comprised of a felt layer, which is the lining surface that contacts the interior surface of the host pipe, and a polymer coating is on the opposite surface.

FIGS. 2 and 3 show the repair assembly 10 within a main pipe line 50 which is connected to a lateral pipe line 52. The damaged portion 54 is shown needing repair. Ground water from outside the lateral pipe line 52 and the main pipe line 50 will seep through the damaged portion 54 and enter the interior of the main pipe line 50 and the lateral pipe line 52.

In order to help prevent this seepage of ground water, a gasket 56 is positioned about a portion of the liner assembly 14. The gasket 56 includes a tubular portion 60 that extends at least partially within the lateral liner tube 40 and a flange portion 58 that extends outwardly about the periphery of one end of the tubular portion 60. The flange portion 58 of the gasket 56 is preferably attached to the main liner tube 38 around the juncture between the main liner tube 38 and the lateral liner tube 40 so as to help maintain the gasket 56 in proper position as the repair assembly 10 is positioned for operation. The gasket 56 is preferably made of a hydrophilic material capable of swelling in response to being exposed to water or other liquid. However, other materials for the gasket 56 found suitable include neoprene rubber, other similar gasket materials such as urethane or silicone rubber, and like impermeable compressible materials. Although the precise dimensions of the gasket 56 are not necessarily critical to the present invention, a tubular portion 60 having a length of approximately six inches and a flange portion 58 having a diameter of approximately twelve inches has been found suitable for most sewer pipe applications.

As shown in FIGS. 1-3, two hydrophilic containment bands 80 are positioned on different sides of the gasket 56 and over a portion of the gasket 56 so the two components 56, 80 are overlapping. In one embodiment the containment bands 80 are placed over different portions of the flange 58 of the gasket 56. The placement of the containment bands 80 over portions of the gasket 56 allows the containment bands 80 to function as straps which help secure the gasket 56 to the assembly 10 as the launcher device 12 travels through the pipe 50. In some embodiments, no additional securing means is needed to secure the gasket 56 to the assembly 10.

The containment bands 80 are positioned around the outer portion of the main liner 38 to form a ring around the liner 38. The containment bands 80 are positioned on different sides of the main/lateral junction opening so that after the liner assembly 14 is urged toward the pipe 50, 52 (FIG. 3), each containment band 80 forms a seal between the main liner member 38 and the internal walls of the pipe 50 on either side of the junction opening. This helps contain water by preventing it from traveling along the pipe 50 between the outside of the liner 38 and the inside of the pipe 50. The containment bands 80 are between the internal wall of the pipe 50 and the gasket 56 at the area where the two components 56, 80 overlap. The hydrophilic containment bands 80 are capable of swelling in response to being exposed to a liquid, such as water. In embodiments where the containment bands 80 are made from the same hydrophilic material as the gasket 56, both components swell in similar proportion to form an improved sealing assembly.

As shown best in FIG. 1, in one embodiment the containment bands 80 are positioned around the liner 38 at an angle so the upper (first) portion of the containment bands 80 (where the containment bands 80 contact and are placed over the gasket 56) are a first distance apart and the lower (second) portion of the containment bands 80 are a second distance apart. The first distance is greater than the second distance so the containment bands 80 are farther apart on the top of the liner 38. This configuration helps the containment bands 80 hold the gasket 56 in its desired position.

As best shown in FIG. 2, in some embodiments the containment bands 80 have a rectangular cross-sectional shape resulting in a greater width than height. The shape may be similar to that of a rubber-band wherein the width is about twice the length of the height. The increased width provides more surface area between the containment band 80 and the liner 38. Although the precise dimensions of the containment bands 80 are not necessarily critical to the present invention, in some embodiments the containment bands 80 may be about 0.16 inches (4 mm) wide and about 0.08 inches (2 mm) tall.

FIG. 2 shows the repair assembly 10 moved within the main pipe line 50 adjacent the lateral pipe line 52. The launcher device opening 46 is registered with a junction between a lateral pipe line 52 and the main pipe line 50. This alignment is done with a TV camera (not shown). The lateral bladder tube 36 and the lateral liner tube 40 are contained within the launcher device cavity 48. It should be noted that the lateral liner tube 40 and tubular portion 60 of the gasket 56 extend within the lateral bladder tube 56 in FIG. 2; whereas, the main liner tube 38 and the flange portion 60 of the gasket 56 remain outside the main bladder tube 34 on the exterior of the launcher device 12. Air pressure is introduced in the cavity 48 through air hose 32, urging the liner tube assembly 14 into contact with the interior walls of the main pipe line 50 and the lateral pipe line 52. Continued air pressure causes the lateral bladder tube 36 and the lateral liner tube 40 to invert outwardly through the launcher device opening into the lateral pipe line 52 from the position shown in FIG. 2 to the position shown in FIG. 3. While air is the preferred pressurized material, other gasses or fluids may be used. It should be noted that this inversion process causes the lateral liner tube 40 to be placed on the outside of the bladder tube 36 once the inversion is complete, as shown in FIG. 3. In this position, the gasket 56 and containment bands 80 are positioned between the main liner tube assembly 14 and the interior walls of the main pipe line 50. The gasket 56 is positioned between the lateral liner tube assembly 16 and the interior walls of the lateral pipe line 52. Pressure within cavity 48 is maintained until the liquid hardenable material, preferably a resin activated with a catalyst, cures and hardens. This results in the liner assembly 14 assuming a rigid configuration, forming a lining to the lateral pipe line 52 and the main pipe line 50.

The ground water, as designated by the arrows 90 in FIG. 3, can seep towards the hydrophilic gasket 56 and containment bands 80. However, upon encountering the hydrophilic gasket 56 and/or containment bands 80, the water causes the gasket 56 and/or bands 80 to expand in both a radial inward direction and a radial outward direction. This causes the gasket 56 to form a water tight seal between the T-shaped or Y-shaped liner assembly 14 and the interior walls of the main pipe line 50 and the lateral pipe line 52. The expansion of the containment bands 80 causes the bands 80 to form a water tight seal around the main liner 38 and the interior walls of the main pipe line 50 to help contain water and prevent it from traveling along the pipe line 50 between the main liner 38 and the main pipe 50. The gasket 56 and the bands 80 work together to form an improved sealing assembly.

While one embodiment of the invention is intended for use with an inversion-type application wherein the lateral bladder tube 36 and the lateral liner tube 40 invert outwardly into the lateral pipe line 52, those skilled in the art will appreciate that the gasket 56 can also be used in pull-in-place applications. In a pull-in-place application, the gasket 56 can be threaded down the lateral liner tube 40 to the juncture between the main liner tube 38 and the lateral liner tube 40. In such a pull-in-place application, it is less important that the gasket 56 be attached to the liner assembly 14, as the gasket 56 will tend to stay in proper position as the lateral bladder tube 36 and lateral liner tube 40 are moved through the main pipe line 50 and ultimately into the lateral pipe line 52 while at the same time the main bladder tube 34 and main liner tube 38 are moved along the main pipe line 50 to a position adjacent the opening to the lateral pipe line 52.

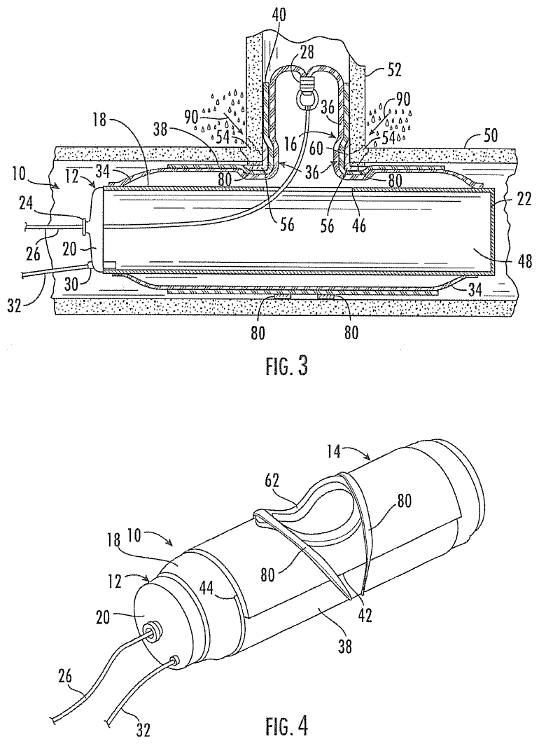

FIGS. 4, 5 and 6 illustrate an alternative embodiment of the present invention wherein the gasket 56 is replaced with a ring-shaped junction band 62 of hydrophilic material or like impermeable compressible material. The junction band 62 is positioned on the main liner tube 38 and extends around the juncture between the main liner tube 38 and the lateral liner tube 40. The junction band 62 is again preferably made of a hydrophilic material and swells in response to being exposed to water or other liquid. In specific, the junction band 62 expands outwardly and inwardly in a radial direction to effectively seal the area between the liner assembly 14 and the juncture between the main pipe line 50 and lateral pipe line 52.

As shown in FIGS. 4-6, two hydrophilic containment bands 80 are positioned on different sides of the junction band 62, over a portion of the junction band 62 so the two components are overlapping. The containment bands 80 may be the same bands 80 are described above with respect to FIGS. 1-3. The placement of the containment bands 80 over portions of the junction band 62 allows the containment bands 80 to function as straps which helps secure the junction band 62 to the assembly 10 as the launcher device 12 travels through the pipe 50. In some embodiments, no additional securing means is needed to secure the junction band 62 to the assembly 10.

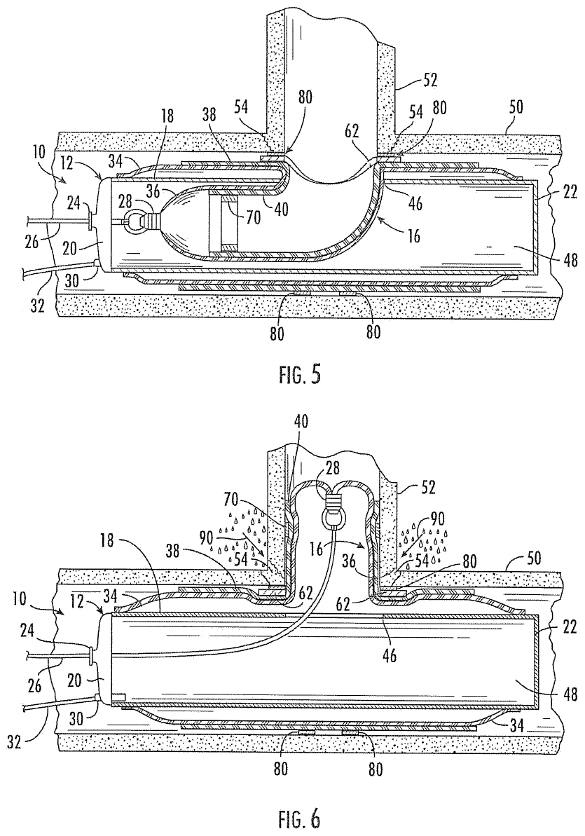

The containment bands 80 are positioned around the outer portion of the main liner 38 to form a ring around the liner 38. The containment bands 80 are positioned on different sides of the main/lateral junction opening so that after the liner assembly 14 is urged toward the pipe 50, 52 (FIG. 6), the containment bands 80 form a seal around the entire liner member 38 on each side of the junction opening. This helps contain water by preventing it from traveling along the pipe 50 between the outside of the liner 38 and the inside of the pipe 50. The containment bands 80 are between the internal wall of the pipe 50 and the junction band 62 at the area where the two components 62, 80 overlap. The hydrophilic containment bands 80 are capable of swelling in response to being exposed to a liquid, such as water. In embodiments where the containment bands 80 are made from the same hydrophilic material as the junction band 62, both components swell in similar proportion to form an improved sealing assembly.

As shown best in FIG. 4, in one embodiment the containment bands 80 are positioned around the liner 38 at an angle so the upper (first) portion of the containment bands 80 (where the containment bands 80 contact and are placed over the junction band 62) are a first distance apart and the lower (second) portion of the containment bands 80 are a second distance apart. The first distance is greater than the second distance so the containment bands 80 are farther apart on the top of the liner 38. This configuration helps the containment bands 80 hold the containment band 62 in its desired position.

In applications where the lateral liner tube 40 is inverted into the lateral pipe line 52, the junction band 62 may be attached to the main liner tube 38 to secure the band 62 in place. The band 62 can be attached by means of stitching, stapling, or by use of an adhesive or similar attachment means. The junction band 62 may be made from a hydrophilic material such as the one described previously.

In some embodiments a third hydrophilic seal 70, which may be a hydrophilic O-ring, may be placed within the interior of the lateral liner tube 40 as shown in FIG. 5. Upon inversion the seal 70 is positioned between the lateral liner 40 and the interior wall of the lateral pipe 52 to help seal the terminal end of the lateral liner tube 40 with the lateral pipe 52. This third seal 70 may also be used in other embodiments, such as the embodiments described with respect to FIGS. 1-3.

The invention has been shown and described above with reference to the preferred embodiments, and it is understood that many modifications, substitutions, and additions may be made which are within the intended spirit and scope of the invention. The invention is only to be limited by the claims appended hereto.

1. An apparatus for repairing a main pipe line and a lateral pipe line connected thereto and in communication therewith to form a pipe joint, the apparatus comprising:
a liner assembly comprising a main liner member and a lateral liner tube of resin absorbent material in communication with one another through a liner juncture, the lateral liner tube being adapted to extend within the lateral pipe line and the main liner member being adapted to extend within the main pipe line;
a gasket surrounding a portion of the lateral liner tube and the main liner member near the liner juncture, wherein the gasket includes a tubular portion having a first end and a second end and a flange portion extending outwardly from one of the first and second ends of the tubular portion;
a first containment band surrounding the main liner member and being positioned over a first portion of the flange portion of the gasket, the first containment band adapted to be positioned between the first portion of the flange portion of the gasket and the main pipe line on one side of the liner juncture; and
a second containment band surrounding the main liner member and being positioned over a second portion of the flange portion of the gasket, the second containment band adapted to be positioned between the second portion of the flange portion of the gasket and the main pipe line on another side of the liner juncture;
wherein the gasket, first containment band, and second containment band are all made of a hydrophilic material capable of swelling in response to being exposed to a liquid.

2. The apparatus of claim 1 further comprising a bladder assembly comprising a main bladder tube and a lateral bladder tube, the lateral bladder tube being adapted to extend within the lateral pipe line with the lateral bladder tube being inside the lateral liner tube and the lateral liner tube being between the lateral pipe line and the lateral bladder tube, the main bladder tube being adapted to extend within the main pipe line with the main liner member being between the main pipe line and the main bladder tube.

3. The apparatus of claim 1 wherein the main liner member is formed as a tube.

4. The apparatus of claim 2 further comprising a launcher device within the main bladder tube.

5. The apparatus of claim 1 wherein at least one of the first and second containment bands has a rectangular cross-section.

6. The apparatus of claim 5 wherein at least one of the first and second containment bands has a width and a height, and the width is twice the length of the height.

7. The apparatus of claim 1 wherein each of the first and second containment bands has a first portion which overlaps the gasket and a second portion which is opposite the first portion, the first portions are separated by a first distance and the second portions are separated by a second distance, wherein the first distance is greater than the second distance.

8. The apparatus of claim 1 wherein the hydrophilic material is a hydrophilic rubber.

9. A method of repairing a main pipe line and a lateral pipe line connected thereto and in communication therewith to form a pipe juncture, the method comprising:
taking a liner assembly including a main liner member with, an outside portion and a lateral liner tube in communication with one another through a liner juncture;
impregnating the liner assembly with a material capable of curing and hardening;
positioning a gasket having a tubular portion with a first end and a second end and a flange portion extending outwardly from one of the first and second ends of the tubular portion, the gasket positioned with the flange of the gasket being disposed on the outside portion of the main liner member;
positioning a first containment band around the main liner tube between a first portion of the flange portion of the gasket and the main pipe line on one side of the liner juncture;
positioning a second containment band around the main liner tube between a second portion of the flange portion of the gasket and the main pipe line on another side of the liner juncture;
wherein the gasket, first containment band, and second containment band are all made of a hydrophilic material capable of swelling in response to being exposed to a liquid;
moving the lateral liner tube within the lateral pipe line; and
exposing the gasket, first containment band, and second containment band to a liquid that causes them to swell, thereby forming a seal between the liner assembly and the main and lateral pipe lines at the pipe juncture.

10. The method of claim 9 further comprising taking a bladder assembly including a main bladder tube and a lateral bladder tube and moving the lateral bladder tube within the lateral pipe line with the lateral bladder tube being within the lateral liner tube.

11. The method of claim 10 further comprising the steps of pressing the main liner tube and the lateral liner tube radially outwardly against the main line pipe and the lateral pipe line, permitting the curable resin to cure and harden, and removing the launcher device, the main bladder tube and the lateral bladder tube from the main pipe line.

12. The method of claim 9 wherein at least a portion of the tubular portion of the gasket is disposed within the lateral liner tube prior to inverting the lateral liner tube.

13. An apparatus for repairing a main pipe line and a lateral pipe line connected thereto and in communication therewith to form a pipe joint, the apparatus comprising:
a liner assembly comprising a main liner member and a lateral liner tube of resin absorbent material in communication with one another through a liner juncture, the lateral liner tube being adapted to extend within the lateral pipe line and the main liner member being adapted to extend within the main pipe line;
a single junction band surrounding a portion of the lateral liner tube and the main liner member near the liner juncture;
a first containment band surrounding the main liner member and being positioned over a first portion of the single junction band, the first containment band adapted to be positioned between the first portion of the single junction band and the main pipe line on one side of the liner juncture; and
a second containment band surrounding the main liner member and being positioned over a second portion of the single junction band, the second containment band adapted to be positioned between the second portion of the single junction band and the main pipe line on another side of the liner juncture;
wherein the single junction band, first containment band, and second containment band are all made of a hydrophilic material capable of swelling in response to being exposed to a liquid.

14. The apparatus of claim 13 further comprising a bladder assembly comprising a main bladder tube and a lateral bladder tube, the lateral bladder tube being adapted to extend within the lateral pipe line with the lateral bladder tube being inside the lateral liner tube and the lateral liner tube being between the lateral pipe line and the lateral bladder tube, the main bladder tube being adapted to extend within the main pipe line with the main liner member being between the main pipe line and the main bladder tube.

15. The apparatus of claim 13 wherein the main liner member is formed as a tube.

16. The apparatus of claim 14 further comprising a launcher device within the main bladder tube.

17. The apparatus of claim 13 wherein at least one of the first and second containment bands has a rectangular cross-section.

18. The apparatus of claim 13 wherein at least one of the first and second containment bands has a width and a height, and the width is twice the length of the height.

19. The apparatus of claim 13 wherein each of the first and second containment bands has a first portion which overlaps the gasket and a second portion which is opposite the first portion, the first portions are separated by a first distance and the second portions are separated by a second distance, wherein the first distance is greater than the second distance.

20. The apparatus of claim 13 wherein the hydrophilic material is a hydrophilic rubber.

21. A method of repairing a main pipe line and a lateral pipe line connected thereto and in communication therewith to form a pipe juncture, the method comprising:
taking a liner assembly including a main liner member with an outside portion and a lateral liner tube in communication with one another through a liner juncture;
impregnating the liner assembly with a material capable of curing and hardening;
positioning a single junction band disposed on the outside portion of the main liner member;
positioning a first containment band around the main liner tube between a first portion of the single junction band and the main pipe line on one side of the liner juncture;
positioning a second containment band around the main liner tube between a second portion of the single junction band and the main pipe line on another side of the liner juncture;
wherein the single junction band, first containment band, and second containment band are all made of a hydrophilic material capable of swelling in response to being exposed to a liquid;
moving the lateral liner tube within the lateral pipe; and
exposing the single junction band, first containment band, and second containment band to a liquid that causes them to swell, thereby forming a seal between, the liner assembly and the main and lateral pipe lines at the pipe juncture.

22. The method of claim 21 further comprising taking a bladder assembly including a main bladder tube and a lateral bladder tube and moving the lateral bladder tube within the lateral pipe line with the lateral bladder tube being within the lateral liner tube.

23. The method of claim 22 and further comprising the steps of pressing the main liner tube and the lateral liner tube radially outwardly against the main line pipe and the lateral pipe line, permitting the curable resin to cure and harden, and removing the launcher device, the main bladder tube and the lateral bladder tube from the main pipe line.

24. The method of claim 21 wherein at least a portion of the tubular portion of the single junction band is disposed within the lateral liner tube prior to inverting the lateral liner tube.
